(19) United States
(12) Patent Application Publication
(10) Pub. No.: US 2023/0022234 A1
(43) Pub. Date: Jan. 26, 2023

(54) Physical Item Control

(71) Applicant: 4k.com Corporation, Las Vegas, NV (US)

(72) Inventors: Stephen Gu, San Diego, CA (US); Yang Li, Las Vegas, NV (US); Tyler Sullberg, Los Angeles, CA (US); Max Einhorn, San Francisco, CA (US)

(73) Assignee: 4k.com Corporation, Las Vegas, NV (US)

(21) Appl. No.: 17/813,475

(22) Filed: Jul. 19, 2022

Related U.S. Application Data
(60) Provisional application No. 63/203,348, filed on Jul. 19, 2021.
(60) Provisional application No. 63/268,263, filed on Feb. 18, 2022.

(51) Int. Cl. G06Q 30/06; H04L 9/00; G06Q 20/38

(52) U.S. Cl. CPC G06Q 30/0621; H04L 9/50; G06Q 20/382

(57) ABSTRACT

The present invention relates to systems and methods for physical item control. The invention further relates to a technological coordination layer protocol for representation of a physical item on a blockchain by a physically backed token minted when the physical item is transferred by its owner or possessor to a guardian user of the protocol. The guardian user delivers the item to a physical location when the physically backed token is burned. While the physical item is in the possession of the guardian user, the condition of the physical item is verified through on-chain audits. The protocol can provide tokens to compensate guardian users.

### CROSS REFERENCE TO RELATED APPLICATIONS

This application claims the benefit of U.S. Provisional Patent Application No. 63/203,348, filed on Jul. 19, 2021, entitled “Systems and Methods for Securitizing Physical Items,” and further claims the benefit of U.S. Provisional Patent Application No. 63/268,263, filed Feb. 18, 2022, entitled “Decentralized Physical Item Protocol,” both of which are hereby incorporated by reference in their entirety.

### FEDERALLY SPONSORED RESEARCH OR DEVELOPMENT

None.

### TECHNICAL FIELD

The present invention relates to systems and methods for physical item control. The invention further relates to a technological coordination layer protocol for representation of a physical item on a blockchain by a physically backed token, including non-fungible tokens (NFT), minted when the physical item is transferred by its owner or possessor to a guardian user of the protocol. The guardian user delivers the item to a physical location when the physically backed token is burned. While the physical items are in the possession of the guardian user, the condition of the physical item is verified through on-chain audits by auditor users and staking pools. The protocol can provide tokens to compensate guardian users and auditor users.

### BACKGROUND

Blockchain technology has transformed how society owns and interacts with items. However, these innovations have to date applied exclusively to digital items. There is no blockchain technology interface to the physical world. A key reason physical items have not been brought on-chain is that the physical world is fundamentally uncertain. Whereas there can be near certainty about the validity of a purely digital on-chain item by replaying the blockchain's transactions since the genesis block, there is no such certainty with physical items. In the real world, there are bad actors, geopolitical instability, and physical decay. There is a need to solve this problem so that physical items can be controlled, secured, and transferred with increased reliability and trust.

Problems with existing physical item marketplaces include high fees, high rates of fraud, and long delivery times. When shopping on internet-based marketplaces, buyers have no way of knowing whether the condition of the item shown in pictures is an accurate representation of the current condition of the item that they will receive when ordered. Even if the item is in the same condition, the buyers have no way of knowing whether the item is a knockoff or authentic. There is need for reliability and trust in marketplaces for physical items.

### SUMMARY

The present invention is a protocol that places physical items on-chain as physically backed tokens. Items are securely held by guardians who guarantee physically backed tokens can be burned in exchange for return of the physical item. Guardians are held accountable through on-chain audits and staking pools. The invention protocol provides a technological coordination layer between the digital and physical worlds.

By creating physically backed tokens, the invention introduces a new composable primitive to the Web3 ecosystem and enables humanity to use physical items in unprecedented ways. With an on-chain representation of a physical item, owners of physically backed tokens can transfer physical items at a fraction of the cost and friction of a traditional transaction. Physically backed tokens can be used as collateral, be fractionalized, form the basis of a stable coin, and be used for other purposes. The invention eliminates a need to be in physical proximity of a physical item in order to use it. Idle physical items can be brought into the metaverse, become the basis for membership into social clubs, and enable countless other use cases.

One aspect of the present invention is the physical guardian protocol, which provides certainty that a physically backed token is truly backed by a physical item. Another aspect of the present invention is an authentication protocol that provides certainty that a physically backed token is what it represents itself to be. Another aspect of the present invention is a valuation protocol to maximize certainty of an item's market price.

The present invention is a novel approach for bridging physical and digital worlds. Previous attempts to create the physical-digital bridge have been centralized, ad-hoc, and rife with misaligned incentives. In comparison, the present invention is decentralized, universal, incentive aligned, composable, chain agnostic, scalable, and transparent.

The invention is decentralized in that items are brought on-chain through a decentralized network of users that play the roles of guardians, authenticators, and appraisers. The network comes to a consensus on whether a physical item is truly backing a physically backed token, whether that item is what it represents itself to be, and how much that item is worth.

The present invention is universal in that the protocol can bring any physical item on-chain, e.g., watches, wine, art, real estate. The invention is incentive aligned in that users of the network, optionally represented by nodes, may have a financial stake in the network and be incentivized to act in the best interest of the protocol. The invention is composable in that the present invention creates a shared framework for interacting with the physical world using tokens. The invention is chain agnostic in that the invention's physically backed tokens can exist on any chain with a token standard. The invention is scalable in that the present invention protocol can bring in millions of items on-chain quickly and efficiently. The invention is transparent in that both the provenance of items and the operations of guardians, including losses, damages, etc., are publicly stored on-chain.

The present invention can exist on decentralized peer-to-peer blockchains and thus provides cross-chain interoperability and can interact with automatic market makers (AMMs) that will be central to the development of the crypto ecosystem moving forward.

### BRIEF DESCRIPTION OF THE DRAWINGS

FIG. 1 is an exemplary schematic diagram of the invention.

FIG. 2 is an exemplary schematic diagram of a physically backed token of the invention.

FIG. 3. is an exemplary flowchart of the lifecycle of a physically backed token of the invention.

FIG. 4 is an exemplary flowchart of a protocol fee distribution aspect of the invention.

FIG. 5. is an exemplary audit, review and enforcement process of an aspect of the invention.

FIG. 6 is an exemplary loss or damage remediation aspect of the invention.

Like reference numerals refer to like parts throughout the several views of the drawings.

While one or more embodiments may be susceptible to various modifications and alternative forms, specific embodiments thereof are shown by way of example in the drawings and will herein be described in detail. It should be understood, however, that the drawings and detailed description thereto are not intended to limit the disclosure to the particular form disclosed, but to the contrary, the disclosure is to cover all modifications, equivalents and alternatives falling within the spirit and scope of this disclosure.

### DETAILED DESCRIPTION

The present invention physical item protocol provides technological coordination of physical items to digital items for physical item control, management, and securitization.

One element of the invention is a physically backed token. A physically backed token is a token that can be redeemed for the physical item by burning the token. A token may conform to the ERC-1155, ERC-721, or ERC-20 standards.

Another element of the invention is a physical guardian protocol that ensures a physically backed token is truly backed by a physical item.

Another element of the invention is proof-of-items. The present invention provides a system by which a decentralized network of guardians prove that they are holding a physical item and are held accountable if that item is lost or damaged. This protocol is what enables one to believe a physically backed token can actually be redeemed for the original physical item without needing to trust any single centralized entity.

Another element of the invention is staking pools. The present invention holds guardians financially accountable for lost items, damaged items, or failure to follow the standards of the protocol. This mechanism also helps reimburse item owners in the event of a loss or damage and serves as a layer of protection beyond the traditional legal system.

One element of the invention is physical oracles. The present invention provides a system for the state of physical items to be routinely recorded on-chain.

Each of these elements of the invention are discussed further below.

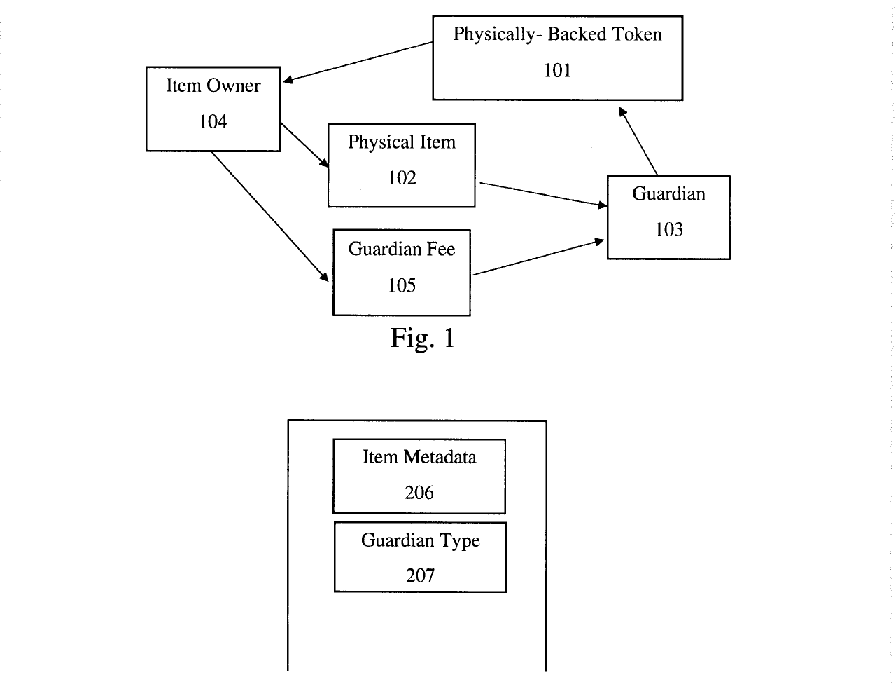

As shown in FIG. 1., a physically backed token 101 is minted when a physical item 102 is placed in the care of a guardian 103. An item owner 104 can redeem their token 101 for the physical item 102 by burning the token.

Guardians 103 are compensated for the cost and risk of holding physical items 102 with guardian fees 105 that may be paid in protocol tokens, United Stated Dollar (USD), stable coins, or other currencies, including cryptocurrencies. If an item owner 104 does not pay their guardian fee 105, the physically backed token 101 may be offered for sale through the protocol, such as in an English-style auction.

Protocol tokens may have multiple purposes across the protocol. Governance and long-term incentive alignment: protocol token holders may be able to lock their protocol tokens in return for other tokens which may earn both more governance rights, emissions, and a cut of protocol fees. Longer locking periods result in more other tokens. This aligns protocol token holders with the long-term interests of the protocol. Accountability and remediation: protocol tokens may be how claims and penalties are paid by guardians. Auctions: Physically-backed tokens with a negative guardian fee balance may be automatically auctioned in the open market.

Consequently, the protocol token may also accrue value in multiple ways. Fees: Fees (guardian, minting, redemption, bridging, etc.) may be paid in stablecoin and into a protocol token/stablecoin liquidity pool, which creates a sustainable source of demand for the protocol token. Locking stakes: The protocol incentivizes long locking periods for protocol tokens, which reduces the velocity of the token. Guardians may be required to have a minimum threshold of locked protocol tokens to participate in the network. Long-term locking/staking incentives are sustainable because stakers receive a portion of protocol fees. Paying penalties and claims: Penalties and claims may be paid out in protocol tokens, and guardians may be required to pay back the value of all claims/penalties in protocol tokens.

In the event of a lost or damaged item, item owners may be compensated through the guardian's on-chain staking pool. This staking pool may be funded through protocol token delegations by the guardian or the community or both. In exchange for the risk of delegating to the staking pool, delegators may receive inflationary rewards of the protocol token.

As shown in FIG. 2, the invention's physically backed token 201 comprises several elements. One element of the invention's physically backed token is item metadata 206. The metadata may include storage, insurance, and royalty data associated with the item. Each item may contain attributes that are common between items, e.g., name, description, category, etc., as well as arbitrary key-value pairs that can be defined by the item owner. The invention protocol may create standards on attributes that must be present for given item categories.

One element of the invention's physically backed token 201 may be guardian type 207, which provides who the guardian 103 is, where the guardian 103 is located, and how the item 102 will be held, e.g., temperature control, location, security level, on-chain insurance caps etc.

One element of the invention's physically backed token 201 may be guardian rate 208, which is the rate that item owner 104 must pay the guardian 103 to hold the item 102.

One element of the invention's physically backed token 201 may be guardian fee balance, which is a balance of tokens from which guardian payments are streamed. Item owners 104 can top up this balance at any time. When the token 201 is transferred to another owner, the remaining guardian fee balance 209 for that item 102 may be returned to the original item owner 104 or carried forward to the next item owner 104.

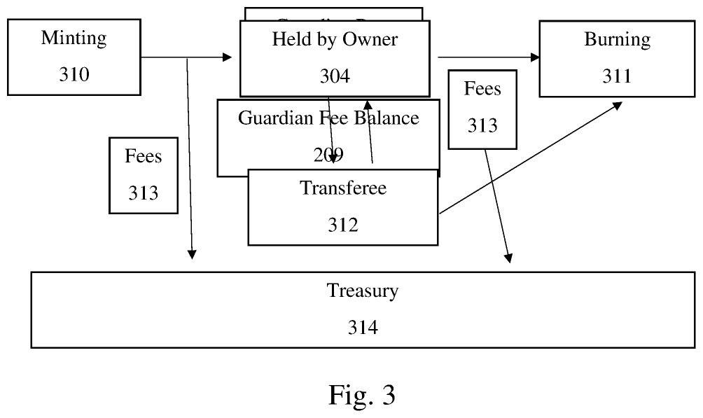

As shown in FIG. 3, each token 201 progresses through the lifecycle of minting 310, being held by the item owner 304, and burning 311. In between, the token 101—which represents the item 102—may be freely transferred to or exchanged between the owner 304 and a transferee 312. The token 101 may also be used in financial platforms, centralized and decentralized. There may be fees 313 associated with each stage of the lifecycle and a portion of these fees 313 accrue to the protocol treasury 314. This fee accrual is described in detail below. The treasury may also collect a marketplace fee, such as 1%, whenever the item is transferred between owners.

A physical guardian protocol creates a digital token that represents ownership of the physical item. For the token to represent ownership, transferring the token must also mean that one is transferring ownership of the physical item. That ownership is only meaningful if the new owner of the token can redeem their token for the physical item. If the holder of the token tries to take possession of the physical item, the holder of the physical item could refuse out of maliciousness, incompetence, loss, damage, or any other reason. The invention solves this agency problem by aligning incentives between the guardian and the owner of the token to securely store the item and return it when requested.

Guardians are responsible for securing a physical item. The physical guardian protocol governs how guardians interact with physical items in two respects. The first is compensation. In exchange for the risk and cost of securing the physical item, guardians are compensated. The second is accountability. Guardians are required to provide proof-of-items and are held accountable for mishandled items.

Guardians are compensated for securing physical items through guardian fees, inspection fees, authentication fees, minting fees, audit fees, redemption fees, and other fees. These fees may be paid with, for example, protocol tokens, USD, USD-denominated stable coins, or other currencies, including cryptocurrencies.

As one example, guardian fees, minting fees, audit fees, and redemption fees are paid to guardians in stable coins, but the guardian does not directly receive stable coins for their rendered services. Instead, fees are automatically deposited into a liquidity pool of stable coins and tokens of the invention protocol. The guardian receives liquidity pool tokens for their rendered services that they can later trade for either stable coins or tokens of the invention protocol.

The physical guardian protocol enables flexibility in how fees are paid. Liquidity pools can be configured to support an arbitrary number of currencies, like balancer pools, giving the user and guardian flexibility in which currency they want to use to pay and receive their guardian fees.

The physical guardian protocol creates liquidity for the token of the invention protocol by providing a sustainable source of demand for the tokens via a steady inflow of stable coins into the liquidity pool.

The physical guardian protocol gives guardians yield on fees by default. These fees accrue both through liquidity pools fees as well as liquidity pool superfluid staking mechanic which allows liquidity providers (LPs) to earn inflationary rewards.

The invention protocol guardian fees are described more fully below.

Guardians charge fees for securely storing an item. While the item is held by the guardian, guardian fees may be continuously charged on-chain with each block via a streaming contract. Guardian fees may be charged on each item individually, and each item may have its own balance. The item owner, who becomes the token holder, pays their guardian fees upfront by topping up the balance on their token. As guardian fees accrue, the fees for a token are automatically deducted from that token's balance. Guardian fees may be denominated and paid with protocol tokens, USD, USD-denominated stable coins, or other currencies, including cryptocurrencies.

For example, a guardian could set their guardian fee for a given class of items at 1 UST per day. If the item owner wants to top up their balance for that item for the next year, they would prepay 365 UST for that physically backed token and that payment would be reflected on the token's balance. After five days have passed, five tokens would be streamed out of this balance to pay the guardian, and the other 360 tokens would remain locked in the token's balance. This example is simplified for the sake of clarity. The guardian may be streamed LP tokens which the guardian can choose to trade in for protocol tokens or stable coins.

The price of guardian fees may be determined competitively between guardians who compete on price, reputation (e.g., number of on-chain audits the node has failed and passed), ability to provide specialized services (e.g., high security, temperate control), on-chain insurance via the staking pool, and off-chain insurance.

While guardians may have full autonomy on setting the fee rates for new physical items entering their care, they may be limited in how quickly they can raise limits, which is expressed as a percentage increase over time, for existing items in their care. The maximum rate at which fees can be raised for existing items held by guardians may be determined by protocol governance. There may be various guardian classes and size categories. The guardian fee is determined via a combination of the level of service the item will receive (the guardian class) and the size of the item (the size category). Each guardian class is a specification on the level of service a given item will receive (e.g., temperature control, security, handling precautions), the maximum on-chain insurance payout for that item in the event of a loss/damage, off-chain insurance coverage, the redemption fee cost, and the guardian fee (fee per block per cubic meter) for that item. Each guardian class contains a set of size categories, which defines how much physical space is assigned to any physical item. In a size category, the guardian defines the criteria that make an item part of that category and the physical space that will be assigned to items within that category. For example, a guardian who specializes in fine spirits may offer two size categories: “0.75 liter bottles” which maps to 0.00075 cubic meters and “1.75 liter bottles” which maps to 0.00175 cubic meters.

The guardian class is selected by the item owner when the physically backed token is minted, whereas the size category is selected by the guardian when the item is inventoried. If the item owner disputes the size category assigned to the item, the owner of the token has the ability to redeem the item within a number of days of being inventoried without a fee. The following represents an example calculation.

Guardian fee/block=[Fee/meter³/block as defined by guardian class]×[meter as defined by size category]

A guardian can choose to activate or deactivate guardian classes and size categories for new items at any time, though guardian classes and sizes for existing items cannot be deactivated.

Minting

Before an item is minted, the item owner pays a minting fee to create an on-chain record of their selected guardian, guardian type, and item metadata (e.g., storage, insurance, and royalty data, item pictures, description). This on-chain record is not to be confused with the physically backed token, which is created once the guardian receives the item. The owner of the physical item then sends their item to the guardian.

The minting fee disincentivizes spamming guardians with low-quality physical items. The minting fee is set by the guardian for each class of guardian. Each guardian is responsible for setting its own minting fee. A percentage of the minting fee is sent to the protocol's treasury and the rest goes to the guardian unless programmed otherwise.

When an item is received, there is a mandatory on-chain audit of that item. During the initial audit, the auditor places a unique identifier on the item and photographs the item. The audit process is described below in detail. Once the on-chain record of the audit is created, the token is automatically minted, which enables the guardian to collect the minting fee and begin collecting guardian fees on the item.

Redemption

When a token owner wants to redeem their token for a physical item, the token owner pays a redemption fee to use the protocol's redemption mechanism and enters the physical address where the item must be sent. Once this occurs, the token is burned, and the item no longer accrues guardian fees.

Redemption fees are set by the guardian for each class individually. A percentage of the redemption fee is sent to the treasury and the rest goes to the guardian unless programmed otherwise.

Once an item is redeemed, there is a mandatory final on-chain audit of that item in which the item is photographed with its unique identifier. The audits at the beginning and end of an item's lifecycle with a guardian are foundational elements of the accountability system described in detail below.

Auctions

If an item reaches a negative balance, a grace period begins. If the item owner does not resolve the item's negative balance within the grace period, the item is automatically sold on the open market, such as via an English auction.

Items purchased in the auction may be paid for with protocol tokens, USD, USD-denominated stable coins, or other currencies, including cryptocurrencies. Proceeds from the auction are first used to pay the negative balance. The remainder is split between the prior item owner who failed to pay their guardian fees (such as 85%), the guardian (such as 10%), and the protocol's treasury (such as 5%). This split can be changed by distributed autonomous organization (DAO) governance. If no one purchases the item in the auction, the guardian becomes the owner of the item.

The invention protocol's auction mechanism is far more efficient than how delinquent accounts are handled in the traditional warehousing industry. Whereas traditional auctions are opaque with high transaction costs, the invention's protocol auction is fully automated and transparent. Auction participants can find all relevant details about an item without seeing the item in person, and the item can change hands without needing to physically move.

Proof-of-Items

Guardians are required to provide proof-of-items to prove that physically backed tokens in their care are actually backed by physical items. Guardians are held accountable via a combination of the audit oracle and on-chain staking pools.

Audit Oracle

Guardians supply proof as to whether an item is truly backing a physically backed token through the audit oracle. These audits are used to hold guardians accountable for losing or damaging physical items. The audit record for each physically backed token is publicly stored on-chain. All items are audited when the item first enters the care of the guardian and again when the item is finally redeemed. Audits are performed regularly and can be initiated in multiple ways.

Audits can be initiated by the owner. The owner can initiate an audit for a fee. This fee is set by each guardian individually. There may be a cap on the maximum fee a guardian can charge for an audit. There may also be a cap on the maximum number of audits an owner can request per item per time period. The audit fee and maximum audit frequency may be set by protocol governance.

Audits can be randomly initiated by the protocol. Every week, the protocol may randomly select a small percentage of items for each guardian to audit. This percentage may be set by protocol governance. The guardian may not earn an audit fee for audits initiated by the protocol.

Audits occur during item inventory and redemption. An audit is required on any item once it enters the guardian's care or when the item is redeemed. These audits may be free of charge.

Audits are performed remotely via video or in-person. During an audit, the guardian is required to display a unique identifier of the item, the item itself, and the hash of a block that was added to the blockchain prior to the creation of the on-chain audit record. The unique identifier attached to the item can have varying levels of security, such as RFID, tamper-evident seals, or diamond-dust identifiers.

Guardians compete to offer robust unique identifiers that are not prone to tampering, hacks, or cloning. The video recording is stored off-chain, while a hash of the video is stored in the on-chain audit record.

The audit is a request for proof, not a final determination, of whether something passes an audit. Owners of the physical item are only reimbursed through the on-chain staking pool after a review has taken place. Reviews are described in detail below.

The protocol sets on-chain standards to ensure high-quality audits.

Automatic penalties may accrue for untimely audits. Guardians set service level agreements (SLAs) for each guardian class on how long audits and redemptions will take to complete. The guardian's staking pool will automatically be charged a penalty for each day that the requested audit has not been completed. This penalty may be changed by DAO governance.

Audits are subject to quality reviews. Anyone can initiate a review of an audit that does not meet the standards of the protocol, such as blurry images or missing unique identifiers. If the Enforcement DAO finds the audit has not been properly conducted, a penalty may automatically be charged to the guardian's staking pool. This penalty may be set by protocol governance.

When in doubt, audits may favor the item owner. If an item is being reviewed as a suspected loss, the Enforcement DAO may interpret failure to produce an audit or poor-quality audits as evidence that the item is lost.

On-Chain Staking Pool

Each guardian has its own on-chain staking pool. This staking pool is an on-chain insurance mechanism for item owners if their item is lost or damaged, requires guardians to have skin in the game, and requires guardians to build a reputation with the community. Staking pools are created with protocol tokens and payouts from the staking pool are made with protocol tokens.

Staking and Delegation

The on-chain staking pool holds guardians financially accountable for losing items, damaging items, or not following the standards of the protocol. The staking pool also insures item owners for lost or damaged items.

To participate in the protocol, guardians may need to stake a minimum threshold of protocol tokens into their staking pool. The minimum requirement may be determined by protocol governance. The guardian must continue to meet these requirements to participate as a guardian.

The community can delegate tokens to a guardian, which is like staking to a validator in proof-of-stake systems. The purpose of the community-delegated tokens is to increase the size of the staking pool and act as a proxy for the guardian's reputation. To be able to receive a delegation, a guardian may need to first have their minimum threshold of protocol tokens staked.

Community members who delegate to a guardian node receive inflationary rewards in return. The guardian node receives a commission of that yield which the guardian is responsible for setting. Guardians compete on their commission rate—more secure and productive nodes will likely be able to command a higher commission rate. In the long term, delegators will be compensated with a cut of the guardian's guardian fees.

Staked tokens may have a locking period. A locking period means guardians and delegators cannot remove their capital when there are claims for mishandled items. The minimum locking period can be, for example, 28 days. Stakers are rewarded with higher yields for longer locking periods. Staked tokens may earn yield in the form of protocol tokens.

The staking pool is used to pay claims when it is determined through an audit that an item has been lost or damaged and penalties that are levied when a guardian does not follow the standards of the protocol.

Although a guardian may only be responsible for a small percentage of the staked tokens in their staking pool, penalties and claims may be disproportionately taken from the guardian's staked tokens. For example, if 10% of the tokens in a given staking pool may come from the guardian, the guardian may still be responsible for 50% of a claim. The percentage of penalties and claims paid by the guardian is set by protocol governance. In the event that the guardian has no staked tokens in the guardian pool, the full penalty or claim comes from delegators. This design increases guardian accountability.

DAO Review

The community may be incentivized to proactively monitor audits to see if there is evidence of lost items, damaged items, or improperly conducted audits. Any user of the protocol can initiate a review of an item from the protocol's enforcement DAO. During a review, the Enforcement DAO determines whether there has been loss or damage of an item and how much that loss or damage is worth. If the Enforcement DAO levies a penalty on the guardian, the individual who initiated the review will receive a portion of that penalty as a reward. The fee to initiate a review and the reward for correctly identifying an issue are both set by protocol governance.

There are different types of review.

One type of review is audit review. An audit not performed correctly, for example images were blurry or a unique identifier was not present on the item, is subject to a penalty for an improperly conducted audit set by protocol governance.

Another type of review is item review. Item reviews are initiated when an item is suspected to be damaged or lost. The maximum amount a guardian will be liable for is defined by the insurance payout cap. The insurance payout cap is defined by the guardian on each guardian class. For example, a guardian may have a “Class A” guardian class that insures an item up to a certain amount, such as $50,000. After Enforcement DAO review, the amount that the guardian is liable for is automatically removed from the guardian's staking pool and deposited in the token owner's account. If the item has been lost, the token is burned.

Another type of review is Guardian review. This review is initiated when the guardian is suspected of systematically being deceptive and not acting in the best interest of the protocol. Penalties for the guardian review are determined by Enforcement DAO.

Audits and reviews are publicly stored on-chain. Item owners will review this transparent record of loss rates, damage rates, and Enforcement DAO penalties to evaluate whether a guardian is reliable.

Staking and Accountability.

The invention staking pool design connects staking rewards to guardian fees. This design may accomplish the following goals. Build trust: An on-chain mechanism to immediately compensate asset owners in the event that the Enforcement DAO determines there are losses or damages. Create accountability: Guardians may be required to have skin in the game, and are held accountable on-chain for losses, damages, and process violations. Align incentives: Long-term stakers may be rewarded with both higher emissions, governance rights, and allocations of protocol fees.

Staking pools may be created with protocol tokens and payouts from the staking pool may be made with protocol tokens.

Staking and Locking

Protocol tokens may be staked and locked in a staking pool in return for other tokens that may be a unit by which protocol token emissions and protocol fees are distributed and governance power is determined. A minimum locking period may be 28 days and a maximum locking period may be 4 years. A protocol token locked in the staking pool may receive other tokens in return and shorter locking periods will receive fewer other tokens.

Other tokens may also be how protocol fees—guardian fees, minting fees, redemption fees, etc.—are distributed to token holders. A percentage of all protocol fees may be awarded to other token holders. This percentage may be determined by protocol governance. As emissions decrease, this percentage of protocol fees may become the primary way in which protocol stakers are rewarded.

The other token system may rewards stakers invested in the long-term success of the protocol with both higher rewards and a more of a say in the direction of the protocol. The other token system may also play an important function in locking capital as a temporary remediation mechanism in the event of losses or damages.

Self-Staking and Remediation

In addition to rewarding long-term stakers, the staking pool may also be designed to act as an instant remediation and accountability mechanism in the event of a loss, damage, or process failure. To participate in the protocol, guardians may need to stake a minimum threshold of protocol tokens into their staking pool. The minimum requirement may be determined by protocol governance. The guardian may be required to continue to meet this staking requirement to participate as a guardian. In the event of a process failure—such as incomplete or improperly completed audits, unprocessed redemptions, etc—penalties may be levied fully against the guardian's self-stake.

In the event that an Enforcement DAO determines there is a damage or loss, temporary remediation for that damage or loss may be taken partially from the guardian's self-stake and partially from the full staking pool. The percentage that comes from the guardian's stake—the coverage ratio—may be set individually for each guardian by protocol governance according to the guardian's level of risk. This allows the protocol to control the aggregate risk taken on by the staking pool. Any remediation taken from the staking pool may be temporary, and the guardian may be required to repay remediation taken paid for by the broader staking pool. Protocol governance can also set a risk cap on the total amount that each guardian can be in debt to the broader staking pool at any given time. When the value of the total outstanding debt of a guardian exceeds the risk cap for that guardian, claims may not be paid out from the broader staking pool.

This design may increase the total value of guaranteed on-chain payouts for losses and damages while also minimizing the risk taken on by stakers in the staking pool.

Since the total on-chain coverage a guardian can offer may be proportional to their self-stake, this system may encourage guardians to increase their skin in the game. An example of how this would work in practice:

An audit discovers there is a lost item and the Enforcement DAO determines the value of this lost item is $1000. When the Enforcement DAO's decision is finalized, $1000 will immediately be sent to the owner of the lost item.

This $1000 is sourced from both the guardian's self-stake and the total staking pool. The protocol governance set the coverage ratio for this guardian at 40%. This means that $400 in other tokens, such as ve4K tokens, will be taken from the guardian's self-stake and the remaining $600 is taken from the larger staking pool. Since all guardians need to have a minimum self-staking threshold to operate on the network, the slashed guardian may need to increase their self stake to be in good standing in the network.

The guardian would be required to pay back $600 to the staking pool to be in good standing with the network and guardians that refuse to pay back will be penalized by the Enforcement DAO. This debt is on-chain and is a signal to the network of whether this node can be trusted. Guardians ultimately have 100% responsibility for covering damages and claims, and guardians will have their own off-chain coverage to cover losses from damages and claims.

If a guardian's self-stake is depleted (i.e. there's a catastrophic event), the guardian will no longer have access to the larger staking pool for reimbursing asset owners. However, if a guardian runs out of self-stake, they are still on the hook for reimbursing asset owners with outstanding claims. These debts are logged on-chain and ultimately need to be paid back into the staking pool by the guardian.

The larger staking pool may act as a temporary means to provide immediate remediation in the event that a guardian has many claims against it in a short amount of time. Guardians are ultimately fully responsible for covering losses and damages.

This mechanism design may ensure guardians have skin in the game, give asset owners who have a lost/damaged item the best user experience possible through instant remediation, and put the onus on the guardian for coordinating off-chain insurance.

Joining and Leaving the Protocol

Joining the protocol may be determined by protocol governance. To join the protocol, a prospective guardian must have at least the minimum threshold of their own tokens staked to their staking pool. Joining the network as a validator may be a fully decentralized process. Community nodes may have lower self-staking and process requirements but not have access to the larger staking pool in the event of a loss or damage.

Joining the protocol as a guardian is a decentralized process—anyone may be able to join as long as they meet the standards of the protocol. To join the protocol, a prospective guardian must have at least the minimum threshold of their own tokens staked to their staking pool.

A guardian can be “jailed” when it is no longer acting in the best interest of the protocol. Jailed guardians may have restrictions placed on them. For example, Guardian fees and redemption fees may continue to accrue, but they may not be collected by the guardian. The guardian's staking pool or self-stake may not accrue inflation rewards while the guardian is jailed. While jailed, the guardian may not accept new items.

A guardian can enter and leave jail in two ways. The DAO can vote to jail guardians that are acting against the best interest of the protocol. The DAO can also vote to remove a guardian from jail. Guardians will automatically be jailed if they no longer meet their minimum token staking threshold or if the guardian fails a certain threshold of reviews in a given time period. Both thresholds are set by protocol governance. Once a guardian meets these thresholds, they will be removed from jail.

The staking pool mechanism may hold guardians accountable for lost and damaged items, such as to prevent malicious guardians from stealing items under their care. The ultimate backstop to prevent a malicious guardian from running off with a guardian's items is legal action taken by a DAO representative. Item owners will need to decide whether they believe that a guardian resides in a jurisdiction with an acceptably reliable rule of law.

Protocol tokens may be interoperable with multiple blockchains and transferred cross-chain. The invention protocol may achieve cross-chain interoperability in phases.

One phase is centralized token bridging. The invention protocol tokens have claim rights to the underlying real-world items they represent. Protocol users trust the protocol to store underlying items. Unlike ERC20 tokens, this unique attribute enables centralized bridging. A protocol developer may bootstrap cross-chain interoperability by burning and minting the tokens in a centralized manner. A user can send the tokens back to the protocol developer on its source blockchain at any time and specify the desired target blockchain to be minted. The protocol developer may then verify the authenticity and re-validate its custody status before burning the original token and minting the new token on the target blockchain. At any given time, only one instance of the token that represents the underlying item exists on any blockchain. The protocol developer operates as a centralized exchange that allows for multi-chain deposits and withdrawals. This may not require a custodian as all transaction metadata may be encoded in the transactions themselves on-chain via smart contracts.

A second phase is decentralized token bridging. Many ERC20 bridges are built across blockchains. Multi-party computing bridges provide strong security guarantees that support token standards such as ERC1155.

Token-compliant bridges may be built across various blockchains. The invention may interoperate with various bridges and integrate with decentralized bridges to enable decentralized token bridging. The invention protocol tokens may bridge across blockchains. Users can also use centralized bridging provided by the protocol developer.

A third phase is cross-chain token marketplace. With decentralized bridging of invention protocol tokens, liquidity may become fragmented. A token listed on one blockchain marketplace may only attract liquidity from that blockchain. The invention protocol provides a cross-chain token market through a multi-chain concurrent listing. An item can be sold across various blockchains at the same time. The invention protocol token may then be minted on the buyer's target chain. This is achieved via integration with cross-chain interoperability protocol as a messaging layer for required metadata passing.

The invention protocol's physically backed tokens may be used in a marketplace. Exchanges on the marketplace may be charged a fee that may be split among the owner of a token, protocol tokens, protocol treasury, the brand of physical item represented by the token, and the original minter of the token. DAO governance may change the split of marketplace fees.

The invention protocol addresses the unique risks of operating in the physical world. The risk mitigation is achieved by the protocol. Guardians are required to stake tokens that are slashed when guardians lose items, damage items, or fail to follow the standards of the protocol, e.g., timely redemptions and audits. Items held by guardians are routinely audited. Each item has a trail of audits from when it enters the care of a guardian to when it is redeemed. These audits allow the Enforcement DAO to determine whether a guardian was responsible for damaging or losing an item. Guardian performance data is publicly available on-chain. Failed audits lost or damaged inventory, and penalties from the Enforcement DAO are publicly viewable on-chain, which enables item owners to choose which guardian to send their items to and how delegators choose which guardian todelegate to. Guardians who do not satisfy requirements of the network no longer receive inflationary rewards and earned guardian fees are withheld. Legal action is the final recourse for grossly negligent or malicious behavior. The protocol provides accountability off-chain outside the legal system. However, in the event of grossly negligent or criminal behavior, e.g., stealing inventory, the guardian may be held responsible under the traditional legal system.

Strategies

If an item degrades over time while in the care of the guardian, the guardian is fully accountable for any unreasonable item degradation in between initial receipt and handoff to the shipper. Damage claims are adjudicated through the on-chain review process.

If a large number of items are lost or damaged at once and a guardian's staking pool cannot cover losses, the staking pool may be designed to cover infrequent losses and damages that may occur during the course of operations. However, in the event of large-scale losses or damages, a guardian's self-stake may be depleted before it can fully cover the claims levied by the Enforcement DAO. In this situation, the guardian may need to increase their self-stake again before the rest of the claims can be paid out. Some asset owners may not get paid out immediately after the Enforcement DAO creates their claim. Guardians may be expected or required to have off-chain insurance or other coverage to cover these losses. Protocol governance may control the catastrophic risk that the staking pool takes on through the coverage ratio and risk cap parameters of each guardian. The total amount of unpaid claims may be publicly visible on-chain and may be an important signal for determining whether a node is trustworthy. The Enforcement DAO may decide to jail guardians who fail to increase their self-stake in a timely manner. The staking pool may not have enough funds to cover penalties levied by the Enforcement DAO. Though the staking pool may have insufficient funds, the guardian may offer off-chain insurance to users. Guardians may compete with each other on the level of off-chain insurance they offer. On-chain insurance payouts may be paid on a first-come, first-serve basis.

Because items may be lost or damaged in transit to or from the guardian, every item is audited, at a minimum, at the time it enters the care of the guardian and at the time the item is redeemed. Since there will be photo documentation of every item across the full lifecycle with the guardian, there is a high degree of certainty as to whether damage or loss occurred with the guardian or in transit. Item owners are responsible for coordinating transit to and from the guardian. Item owners assume the full risk for losses or damages in transit. Item owners may pay for shipping insurance.

A guardian may claim they never received an item when they actually did receive the item. When shipping, the guardian's signature is required when items are initially delivered to the guardian and the item owner's signature is required when items are redeemed.

A guardian may refuse to redeem a token, go bankrupt, or steal the physical item. Under applicable law, a physically backed token may be considered a warehousing receipt. The guardian is legally responsible for bankruptcy or theft according to existing case law for warehousing receipts. The incentives of the invention protocol offer a layer of protection in addition to the court system.

A guardian may pretend they have inventory that they don't have. A guardian could attempt to game the audit system by reusing a single physical item during audits for multiple tokens. In the invention protocol, this scheme would be exceedingly difficult and against the interests of the guardian. Every item is audited when it enters and leaves the care of the guardian. Each audit includes photographic proof of the item along with the item's unique identifier physically attached to the item. This identifier attached to the item can have varying levels of security (e.g., RFID, tamper-evident seals). Guardians compete with each other to offer robust unique identifiers that are not prone to tampering, hacks, or cloning. Guardians who are suspected of systematic manipulation may be required, at the discretion of the enforcement DAO, to cover the expense of in-person audits.

A guardian may not process an audit or redemption or not do so in a timely manner. Each guardian set's their own on-chain SLAs for each guardian class on how long audits and redemptions will take to be completed. For each day that a guardian is late, protocol tokens may be automatically slashed from the guardian's staking pool. This penalty may be set by protocol governance.

If an audit is not done in a timely manner or at all, this risk is mitigated in two ways. First, guardians set SLAs for each guardian class on how long audits and redemptions will take to be complete. The guardian's staking pool will automatically be charged a penalty for each day that the requested audit has not yet been completed. Second, if an item is being reviewed as a suspected loss, the Enforcement DAO will interpret the absence of proof (i.e., failure to produce an audit) as proof of absence (i.e., the item is lost).

If a guardian does not properly perform an audit (e.g., the photograph is blurry, a unique identifier is not placed on the item, a recent blockhash is not in the photograph) it is more difficult to know if and when a guardian damaged or lost an item. This risk is mitigated by allowing anyone to initiate an Enforcement DAO review of an audit. If the Enforcement DAO finds the audit has not been properly conducted, a penalty will automatically be charged to the guardian's staking pool. This penalty is set by protocol governance. If an item is put up for review for the Enforcement DAO and the audit trail contains improperly performed audits, the Enforcement DAO will err on the side of ruling in favor of the item owner.

To avoid item owners colluding to overwhelm the guardian with audit requests that cannot be filled, the cost of an audit will be set by protocol governance such that an attack to overwhelm a guardian would be cost-prohibitive. Protocol governance can also set limits on the frequency of audit requests.

An item owner may send in inauthentic items. A protocol marketplace may take steps to verify the authenticity of any items submitted claiming to be authentic. An authentication protocol can also be implemented as a decentralized way to verify authenticity of a physical item.

If an item owner intentionally or unintentionally sends the wrong item to a guardian, the metadata for that physically backed token will not match the item that is actually being held by the guardian. However, since all items are audited when they are initially inventoried by the guardian, there will always be photo documentation of the actual item being held by the guardian. It would be obvious if the item held by the guardian doesn't match the metadata of the physically backed token.

A guardian could commit on-chain insurance fraud. A guardian could send an item to themselves, intentionally lose the item, and collect the on-chain insurance payment. This scheme would be short-sighted. Records of lost and damaged items are publicly available on-chain, and high loss and damage rates would ruin the guardian's reputation. Guardians who lose too many items will be automatically jailed; in which case they stop receiving inflationary rewards.

The Guardian fee may become mispriced as the value of the protocol token fluctuates. Since guardian fees may be paid upfront with the protocol token, but earned by the guardian over time, the guardian may be exposed to the price volatility of the protocol token. This volatility is a minor risk to the guardian since the cost of storing an item will generally be relatively low. Additionally, minting, redemptions, and audit fees will have little currency risk since these fees are earned immediately when the service is rendered rather than accrued over time. If currency fluctuations prove to be a major issue for guardians, protocol governance may decide to build protections to either insulate guardians from currency risk or allow them to reset their guardian fees for existing customers.

There may be frontend vulnerabilities. The protocol developer may create a front-end for guardians and item owners to manage their inventory. Frontend vulnerabilities could compromise the items of guardians and item owners. The protocol developer may mitigate this risk by open sourcing its frontend products and creating bug bounties.

Centralized hosting of data. The protocol developer may create frontend products for item owners and guardians that will be hosted on traditional web servers. In addition, some data (e.g., photos from audits) may be stored off-chain. Using a traditional web hosting service increases the risk of outages and criticism from the community of the protocol developer being too centralized. The protocol developer may mitigate this risk by storing data on-chain and investing in the resiliency of traditionally hosted web products. The protocol developer may continuously evaluate web3 technology stack and, when possible, move from centralized technologies to decentralized technologies.

The DAO

The protocol developer may progressively decentralize, starting by moving governance to a DAO. The DAO will initially have two core committees. The enforcement committee determines losses, damages, process failures, and malicious behavior. The economics committee proposes upgrades and changes in the economic structure of the protocol.

Authentication Protocol

The invention protocol may be optimized to give certainty on whether a physically backed token is truly backed by the corresponding physical item. The original item owner for whom was minted a physically backed token could have misrepresented the attributes of the physical item (e.g., claiming a cheap clone of a watch is an authentic watch). The protocol governance may help users distinguish trusted items by 1) denoting whether the physically backed token was minted by a trusted party (e.g., directly from the brand itself) and 2) performing additional authenticity checks on items as they are received by guardians. Authentication may be a decentralized process managed by the authentication protocol.

The goal of the authentication protocol is to give users the information they need to determine the likelihood that an item is authentic. The authentication protocol may coordinate a network of authenticators to determine whether an item is actually what it was represented to be. This determination is recorded in an on-chain authentication. An authentication is simply an on-chain record from an authenticator with a determination of an item's authenticity. Items can be authenticated an arbitrary number of times. Each authentication increases the community's confidence that an item is what its metadata claims to be.

A possible implementation of the authentication protocol could be as follows. The invention protocol governance votes who can be an authenticator. For an authenticator to participate in the protocol, they may need to stake a minimum threshold of protocol tokens.

Item owners can request an in-person or remote authentication to be completed by an authenticator. Authenticators earn a fee for each authentication they process. The amount of the fee is determined by each authenticator individually. The authentication can be completed before or after the item enters the care of the guardian. If an authenticator accepts the request, they create an on-chain authentication record with their determination of that item's authenticity.

If the Enforcement DAO determines authenticators are creating false authentications, the authenticator will have their staked tokens slashed and/or will be kicked out of the protocol.

Valuation Protocol

The ability to reliably value physically backed tokens is important for both facilitating transactions and for using the protocol tokens as collateral, such as in decentralized finance.

The valuation protocol may consist of the following parties. Physical Item Pricing Oracles collect data on various websites and manually update estimated pricing of items on a time interval basis. On-chain Appraisers are professionals or anyone the community designates as a credible appraiser for specific classes. On-chain appraisals will have a similar design to the authentication protocol.

Advanced Enforcement DAO

Guardians are held accountable through a review process. For a fee, anyone can initiate a review, which is completed by the Enforcement DAO. A fully decentralized mechanism may also be used for reviewing audits implemented as follows. Reviews may be judged by a decentralized panel of judges. The protocol randomly selects which judges will be on the panel of any given review. Judges are paid in protocol tokens. Anyone can become a judge by staking protocol tokens. The protocol publishes criteria for how judges are to adjudicate different situations (e.g., damaged items or audits that were not done correctly).

During a panel's review, each judge submits their vote for the outcome of the review. The outcome of the review is determined by the majority vote. Judges can only get paid for the review if their vote conforms to the majority vote. The judge's staked protocol tokens are slashed if their vote doesn't conform to the majority vote. There may be mechanisms in place to prevent collusion between judges. There may be an Enforcement DAO responsible for investigating and levying penalties when the guardians or judges are suspected of gaming the protocol.

Fully Fungible Physical Items

The protocol may also support fungible physical items with fungible tokens (e.g., gold bars or items with the same SKU) to allow easier interoperability and integrations with AMM's, LPs and other decentralized finance (DeFi) primitives.

Implementation may occur as follows. Build physically backed token ecosystem by enabling new use cases for physically backed tokens on the EVM ecosystem. Create core protocol with cross-chain interoperability and AMMs as core primitives of the protocol. Create Layer 1 chain for stronger flexibility, performance, and sovereignty.

Provide a marketplace with less fraud, lower fees, and faster settlement times by pre-authenticating and storing items offered on the marketplace so buyers can shop with confidence knowing that what's listed is available, authentic, and could be at their door the very next day. To achieve this implementation, first whitelist various items (such as watches, sneakers, trading cards, and other investment-grade collectibles). Then receive whitelisted item from a user. Authenticate, insure, and store the item and issue the user a digital token redeemable for the physical item at any time. The token holder can do whatever they want with their token. They can sell it on the marketplace, sell it on other marketplaces, hold on to it and simply use the guardian for storage, use it as collateral for a loan, or earn yield by placing it in a liquidity pool. The user can redeem their token for the physical good by sending to the guardian the token along with a shipping address. The user then receives the physical item.

After turning physical goods into tokens, item owners may use those tokens to take out loans and earn yield. The present invention enables item owners to monetize their items in ways and at a scale that was not feasible prior to the advent of blockchain technology.

From a standard user's perspective, anyone can come to the marketplace, buy an item, request that it be sent to them, and have it at their door the next day. Instead of asking to redeem that item and paying shipping, they could opt to keep the item on the platform and use the guardian for storage, resell the item for more money on the marketplace, use that item as collateral to take out a loan, or use that item to earn yield.

The invention protocol enables savings accounts (also known as liquidity pools) that offer high interest rates as well as lending systems that enable people to take out loans instantly (also known as flash loans). Unlike the traditional financial system that has reversible transactions, blockchains have immutability that makes transactions irreversible. This key difference makes it difficult for these two systems to interact with each other. By being able to seamlessly integrate with other blockchains, the invention protocol has full compatibility with liquidity pools, lending protocols, and other DeFi innovations previously only accessible to people with digital items. The invention protocol opens up the DeFi system for physical items.

For example, a liquidity pool is powered by a smart contract, an agreement bound by code, not by law. One can put digital items into liquidity pools because the smart contract underlying the liquidity pools is able to recognize digital items. If the items put into a liquidity pool account for 1% of the total items in the pool, the item owner is typically entitled to 1% of the fees that the liquidity pool generates. The pool generates these fees by charging a transaction fee to anyone who buys an item from the pool. This is a popular way for people to earn yield on their otherwise unproductive items.

The invention protocol enables a smart contract to interact with a physical item so that people can earn yield on their otherwise unproductive physical items by creating a natively digital ownership certificate, a token, that is better than a paper ownership certificate because the token can interact with DeFi. When on a liquidity pool platform, one can take out a loan or earn yield on the item because the platform is putting the token into a DeFi protocol.

Using tokens makes it easy for users to take their items off the platform and into whatever wallet, protocol, or other platform they wish.

In addition to protocol tokens, the invention protocol may optionally implement a protocol token. Tokens align incentives with those of other users. More advantages to issuing tokens for a protocol developer and users include bootstrapping network effects, incentivizing micro behaviors, reducing bot manipulation, and rewarding users for risks they opt into bearing on behalf of the rest of the network.

Tokens are a powerful tool for achieving network effects. Tokens also enable the protocol to incentivize activities that help the ecosystem thrive by offering rewards for users to engage in those activities. For example, a challenge for any new marketplace is overcoming the buyer-seller chicken-and-egg problem, no sellers want to sell on a marketplace with no buyers and no buyers want to go to a marketplace with no sellers. To overcome this issue, the protocol can offer sellers tokens for listing their goods for sale on the marketplace. As the marketplace matures, it can expand into new categories. One can fine-tune the incentivization to reward sellers for selling goods only within a new category, or perhaps for something as specific as a one-of-a-kind signed collector's item. By rewarding specific actions with various amounts of tokens, ecosystem participants can always be aware of what activities would enable them to most help the ecosystem as a whole thrive. Effectively allocating tokens to the activities that most enable the ecosystem to thrive benefits all stakeholders.

Tokens also empower defending against bot attacks. This is especially relevant for the invention protocol because marketplaces may offer highly desirable goods that are notoriously common bot targets. For example, a shoe company might release a limited-edition sneaker and make it available for the first 100 people to buy it online. Average people, even if they are online and refreshing their screen constantly at the time of the drop, usually do not stand a chance at buying an item from high demand drops since the bots are simply too fast, especially if the droppers do not take major defensive precautions. By having a token, the protocol can require a user to have at least a certain number of tokens in order to participate in a drop. This imposes a cost to entering a drop, which makes it more expensive to use a bot and therefore more likely for a non-technical fan to be able to buy a dropped item.

Lastly, tokens also enable rewarding users for risk they bear on behalf of the rest of the network. A common practice in the blockchain world is a process called staking. The most common type of staking is to deposit tokens with an entity, called a node, which runs software that secures the network from attack. If a node acts maliciously, that node is slashed, which means that some or all of that node's deposit is confiscated. In return for the slashing risk that the staker takes on, the staker is rewarded with their pro rata share of any new tokens that the network prints, i.e., token inflation.

An example implementation of a similar structure for the invention protocol would be an insurance pool. A guardian may fully ensure all the items it stores but could have an additional insurance pool that is backed by protocol token holders that choose to stake their tokens. If for any reason there is a loss that would usually be covered by the insurer, the insurance pool could be the first to pay out claims. This may also reduce the cost of insurance premiums.

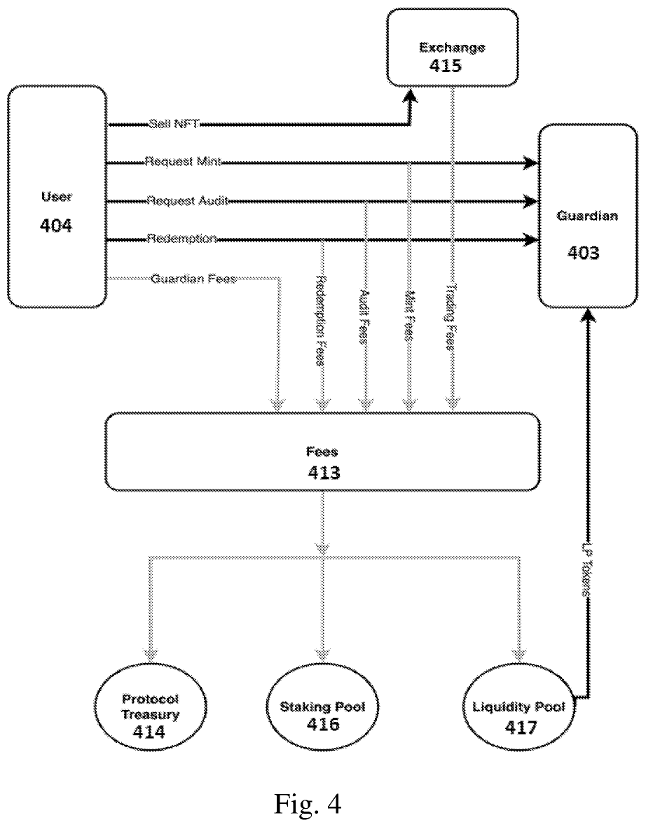

FIG. 4. shows an exemplary flowchart of a protocol fee distribution aspect of the invention. Item owner or user 404 may request mint, audit, or redemption from Guardian 403, sell token or NFT to Exchange, and pay Fees 413, including Guardian Fees, Redemption Fees, Audit Fees, and Mint Fees. Trading Fees may be paid by the Exchange 415. Fees 413 may be allocated to Protocol Treasury 414, Staking Pool 416, or Liquidity Pool 417. Liquidity Pool may transfer tokens to Guardian 403.

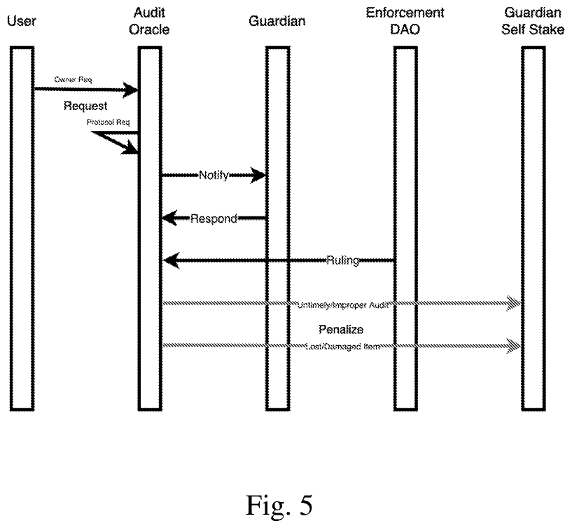

FIG. 5. shows an exemplary audit, review and enforcement process of an aspect of the invention. An item owner or user may send a request to an audit coracle which may notify a guardian that may respond. An Enforcement DAO may send a ruling to the Audit Oracle who may penalize the Guardian Self Stake, such as for being untimely or improper audit or for a lost or damaged item.

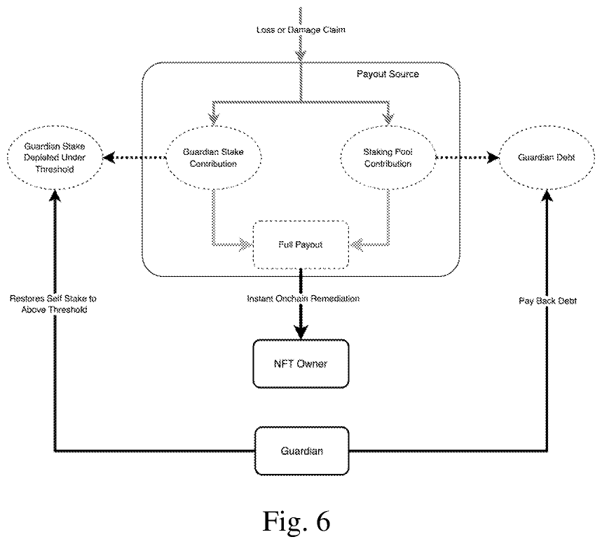

FIG. 6 shows an exemplary loss or damage remediation aspect of the invention. A loss or damage claim may result in a Guardian Stake Contribution or Staking Pool Contribution, that may either separately or combined full payment to the user or item owner. A Guardian may restore self stake to above threshold if Guardian Stake is depleted under threshold after Guardian Stake Contribution. A Guardian may pay back debt if there is Guardian Debt as a result of a staking pool contribution.

All publications and patent documents cited in this application are incorporated by reference in pertinent part for all purposes to the same extent as if each individual publication or patent document were so individually denoted. By citation of various references in this document, Applicants do not admit any particular reference is “prior art” to their invention. It is to be appreciated that the foregoing Detailed Description section, and not the Abstract section, is intended to be used to interpret the claims. The Abstract section may set forth one or more, but not all, exemplary embodiments of the present invention as contemplated by the inventor(s), and thus, is not intended to limit the present invention and the appended claims in any way.

The foregoing description of the specific embodiments should fully reveal the general nature of the invention so that others can, by applying knowledge within the skill of the art, readily modify and/or adapt for various applications such specific embodiments, without undue experimentation, without departing from the general concept of the present invention.

Moreover, the breadth and scope of the present invention should not be limited by any of the above-described exemplary and illustrative embodiments but should be defined only in accordance with the below claims and their equivalents.

Because many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents. From the foregoing, it will be seen that this application is one well adapted to attain all the ends and objects hereinabove set forth together with other advantages which are obvious, and which are inherent to the structure.

It will be understood that certain features and sub-combinations are of utility and may be employed without reference to other features and sub-combinations. This is contemplated by and is within the scope of the claims.

While various embodiments have been described and illustrated herein, one will readily envision a variety of other means and/or structures for performing the function and/or obtaining the results and/or one or more of the advantages described herein, and each of such variations and/or modifications is deemed to be within the scope of the embodiments described herein. More generally, one will readily appreciate that all parameters, dimensions, materials, and configurations described herein are meant to be exemplary and that the actual parameters, dimensions, materials, and/or configurations will depend upon the specific application or applications for which the teachings is/are used. One will recognize or be able to ascertain using no more than routine experimentation, many equivalents to the specific embodiments described herein. It is, therefore, to be understood that the foregoing embodiments are presented by way of example only and that, within the scope of the disclosure, including the appended claims and equivalents thereto, disclosed embodiments may be practiced otherwise than as specifically described and claimed. Embodiments of the present disclosure are directed to each individual feature, system, tool, element, component, and/or method described herein. In addition, any combination of two or more such features, systems, articles, elements, components, and/or methods, if such features, systems, articles, elements, components, and/or methods are not mutually inconsistent, is included within the scope of the present disclosure.

The above-described embodiments can be implemented in any of numerous ways. For example, embodiments may be implemented using hardware, software or a combination thereof. When implemented in software, the software code can be stored (e.g., on non-transitory memory) and executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, netbook computer, or a tablet computer. Additionally, a computer may be embedded in a device not generally regarded as a computer but with suitable processing capabilities, including a smart phone, smart device, or any other suitable portable or fixed electronic device.

Also, a computer can have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer can receive input information through speech recognition or in other audible format.

Such computers can be interconnected by one or more networks in any suitable form, including a local area network or a wide area network, such as an enterprise network, and intelligent network (IN) or the Internet. Such networks can be based on any suitable technology and can operate according to any suitable protocol and can include wireless networks, wired networks or fiber optic networks.

The various methods or processes outlined herein can be coded as software that is executable on one or more processors that employ any one of a variety of operating systems or platforms. Additionally, such software can be written using any of a number of suitable programming languages and/or programming or scripting tools, and also can be compiled as executable machine language code or intermediate code that is executed on a framework or virtual machine.

In this respect, various disclosed concepts can be embodied as a computer readable storage medium or multiple computer readable storage media (e.g., a computer memory) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” are used herein in a generic sense to refer to any type of computer code or set of computer-executable instructions that can be employed to program a computer or other processor to implement various aspects of embodiments as discussed above. One or more computer programs that when executed perform methods of the present disclosure need not reside on a single computer or processor but can be distributed amongst a number of different computers or processors to implement various aspects of the disclosure.

Computer-executable instructions can be in many forms, such as program modules, executed by one or more computers or other devices. Generally, program modules include routines, programs, objects, components, data structures, etc. that perform particular tasks or implement particular abstract data types. Typically, the functionality of the program modules can be combined or distributed as desired in various embodiments.

Also, data structures can be stored in computer-readable media in any suitable form. For simplicity of illustration, data structures may be shown to have fields that are related through location in the data structure. Such relationships can likewise be achieved by assigning storage for the fields with locations in a computer-readable medium that convey relationship between the fields. However, any suitable mechanism can be used to establish a relationship between information in fields of a data structure, including through the use of pointers, tags or other mechanisms that establish relationship between data elements.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), or other types of mobile devices. The mobile devices can communicate wirelessly (for example, using radio frequency (RF) signals) to various communication networks (described below).

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

Also, various concepts can be embodied as one or more methods, of which an example has been provided. The acts performed as part of the method may be ordered in any suitable way. Accordingly, embodiments can be constructed in which acts are performed in an order different than illustrated, which can include performing some acts simultaneously, even though shown as sequential acts in illustrative embodiments. All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in claims, shall have its ordinary meaning as used in the field of patent law.

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

All transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A computer implemented physical item protocol method comprising:
receiving an encrypted record on a processor node on a blockchain network of a request by an owner of a physical item to mint a token associated with the physical item after the physical item is physically transferred to a guardian having a guardian node on the blockchain network and a physical storage facility;
receiving an encrypted record on the processor node of an initial audit of the physical item by the guardian;
receiving an encrypted record on the processor node of minting a token associated with the physical item to an address on the blockchain network of the owner of the physical item;
receiving an encrypted record on the processor node of a redemption request by the owner from the owner address;
receiving an encrypted record on the processor node of approval of the redemption request by the guardian;
receiving an encrypted record on the processor node of a burning of the token; and,
receiving an encrypted record on the processor node of a final audit of the physical item by the guardian.

2. The method of claim 1 wherein the token is a non-fungible token.

3. The method of claim 1 wherein the token is a fungible token.

4. The method of claim 1 wherein the token comprises item metadata.

5. The method of claim 1 further comprising receiving an encrypted record on the processor node of transfer of a payment token from an owner address to the guardian node.

6. The method of claim 5 wherein the payment token is a protocol token.

7. The method of claim 4 wherein the metadata comprises storage, insurance, and royalty data.

8. The method of claim 1 further comprising receiving an encrypted record on the processor mode of an intermediate audit of the physical item by the guardian.

9. The method of claim 8 wherein the intermediate audit is requested by owner.

10. The method of claim 8 wherein the intermediate audit is requested by the protocol.

11. A computer system for physical item control comprising:
a node on a blockchain network comprising a processor and memory configured to store in memory:
an encrypted record of a request by an owner of a physical item to mint a token associated with the physical item after the physical item is physically transferred to a guardian having a guardian node on the blockchain network and a physical storage facility;
an encrypted record of an initial audit of the physical item by the guardian;
an encrypted record of minting a token associated with the physical item to an address on the blockchain network of the owner of the physical item;
an encrypted record of a redemption request by the owner from the owner address;
an encrypted record of approval of the redemption request by the guardian;
an encrypted record of burning the token; and
an encrypted record of a final audit of the physical item by the guardian.

12. The system of claim 11 wherein the token is a non-fungible token.

13. The system of claim 11 wherein the token is a fungible token.

14. The system of claim 11 wherein the token comprises item metadata.

15. The system of claim 11 further comprising an encrypted record of transfer of a payment token from the owner address to the guardian node.

16. The system of claim 15 wherein the payment token is a protocol token.

17. The system of claim 14 wherein the metadata comprises storage, insurance, and royalty data.

18. The system of claim 11 further comprising an encrypted record of an intermediate audit of the physical item by the guardian

19. The system of claim 18 wherein the intermediate audit is requested by owner.

20. The system of claim 18 wherein the intermediate audit is requested by the protocol.
